(19) United States
(12) Patent Application Publication
(10) Pub. No.: US 2026/0241869 A1
(43) Pub. Date: Aug. 20, 2026

(54) STORAGE SYSTEMS MOUNTABLE TO VEHICLES

(71) Applicant: Toyota Motor Engineering & Manufacturing North America, Inc., Plano, TX (US)

(72) Inventor: Aaron R. Steinhilb, Milan, MI (US)

(73) Assignees: Toyota Motor Engineering & Manufacturing North America, Inc., Plano, TX (US); Toyota Jidosha Kabushiki Kaisha, Aichi-Ken (JP)

(21) Appl. No.: 19/058,727

(22) Filed: Feb. 20, 2025

(51) Int. Cl. B60R 9/06

(52) U.S. Cl. CPC B60R 9/065

(57) ABSTRACT

A storage system mountable to a vehicle includes a housing, a drawer movable into and out of the housing, and a rail configured to be mounted to a bed of the vehicle, with the rail defining an interior and a channel opening into the interior. The storage system includes a quick-mount attachment mounted to the housing. The quick-mount attachment includes a lever having a handle, a shoulder, and a body extending between and mounted to each of the handle and the shoulder. The shoulder is shaped to pass through the channel in a first position to allow movement of the lever through the channel into and out of the interior of the rail and to engage the rail and inhibit the movement through the channel in a second position for retaining the shoulder in the interior of the rail and mounting the housing to the rail.

### TECHNICAL FIELD

The present specification generally relates to storage systems and, more specifically, storage systems mountable to vehicles.

### BACKGROUND

The use of vehicles on off-road trails is a hobby for many vehicle operators. The remote nature duration of off-roading often requires the vehicle operator to pack the vehicle with items for the various situations they might experience and for the duration of the trip. The items may include off road gear, tools, food, clothing, camping equipment, and other items. The vehicle operators may desire to package the items within drawers to organize the items and to reduce movement of the items within the vehicle. Current storage containers, having drawers, are permanently installed into the cabs of pickup trucks, which takes up interior space and cannot be easily removed to regain the interior space.

Accordingly, a need exists for storage systems mountable to vehicles.

### SUMMARY

In one embodiment, a storage system mountable to a vehicle may include a housing, a drawer movable into and out of the housing, and a rail configured to be mounted to a bed of the vehicle, with the rail defining an interior and a channel opening into the interior. The storage system may further include a quick-mount attachment mounted to the housing. The quick-mount attachment may include a lever having a handle, a shoulder, and a body extending between and mounted to each of the handle and the shoulder. The shoulder may be shaped to pass through the channel in a first position to allow movement of the lever through the channel into and out of the interior of the rail and to engage the rail and inhibit the movement through the channel in a second position for retaining the shoulder in the interior of the rail and mounting the housing to the rail.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle and a storage system, according to one or more embodiments shown and described herein;

FIG. 2 schematically depicts a top plan view of a portion of the storage system of FIG. 1, showing a rail, walls, a retainer, and a quick-mount attachment, according to one or more embodiments shown and described herein; and

FIG. 3 schematically depicts a cross-sectional view of the portion of the storage system taken along line 3-3 of FIG. 2, according to one or more embodiments shown and described herein.

### DETAILED DESCRIPTION

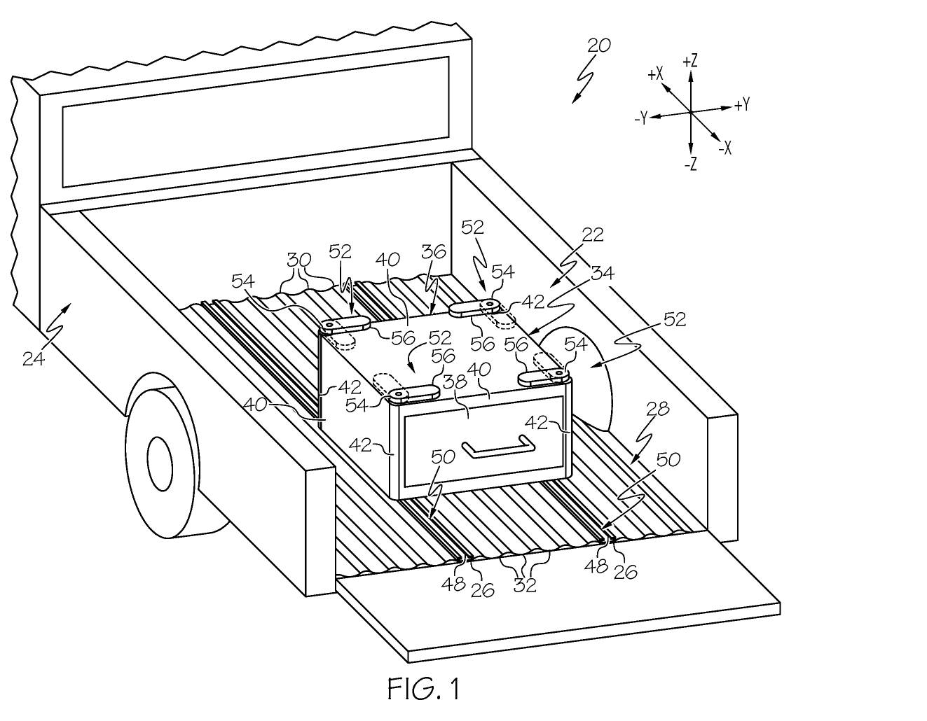

FIG. 1 generally depicts a storage system mountable to a vehicle. The storage system may include a housing, a drawer movable into and out of the housing, and a rail configured to be mounted to a bed of the vehicle, with the rail defining an interior and a channel opening into the interior. The storage system may further include a quick-mount attachment mounted to the housing. The quick-mount attachment may include a lever having a handle, a shoulder, and a body extending between and mounted to each of the handle and the shoulder. The shoulder may be shaped to pass through the channel in a first position to allow movement of the lever through the channel into and out of the interior of the rail and to engage the rail and inhibit the movement through the channel in a second position for retaining the shoulder in the interior of the rail and mounting the housing to the rail.

Previous ways of storing items within a vehicle involved use of storage containers having drawers. However, the storage containers are permanently installed into the cab of the vehicle, which takes up interior space and cannot be easily removed to regain the interior space. The embodiments described herein provide the storage system that is mountable to the vehicle. When the lever is in the second position, the housing is mounted to the rail and secured relative to the vehicle. When the lever is in the first position, the housing and the drawer may be removed from the vehicle with only the rail left behind, freeing up space within the vehicle. Various embodiments and benefits of the storage box system and the storage box will be described in more detail herein.

As used herein, the term “vehicle longitudinal direction” refers to the forward-rearward direction of the vehicle (i.e., in the +/- X direction of the coordinate axes depicted in FIG. 1). The term “vehicle lateral direction” refers to the cross-vehicle direction (i.e., in the +/- Y direction of the coordinate axes depicted in FIG. 1), and is transverse to the vehicle longitudinal direction. The term “vehicle vertical direction” refers to the upward-downward direction of the vehicle (i.e., in the +/- Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a vehicle 20 is provided with a storage system 22, in accordance with one or more embodiments of the present disclosure. The storage system 22 is used for securing items within the vehicle 20, which may otherwise move within or be expelled from the vehicle 20 during operation of the vehicle 20. FIG. 1 is an embodiment in which the vehicle 20 is configured as a pickup truck having a bed 24, with the storage system 22 mounted to the bed 24. However, the storage system 22 may be used in other locations within the vehicle 20, such as a trunk, a passenger cabin, a cargo area, etc. Furthermore, the location shown in FIG. 1 is merely demonstrative and may vary in position, size, number, etc. Moreover, while the vehicle 20 shown in FIG. 1 is configured as a pickup truck, the storage system 22 may be used in any configuration of a vehicle (e.g., a passenger car, a van, a sport-utility vehicle, a crossover vehicle, airplane, boat, etc.) and may be used in any suitable location within the vehicle 20.

The storage system 22 may include a pair of rails 26 configured to be mounted to the bed 24 of the vehicle 20. More specifically, the pair of rails 26 may be mounted to a floor 28 of the bed 24. The floor 28 includes a plurality of ridges 30 and a plurality of valleys 32 extending in the vehicle longitudinal direction X. The plurality of valleys 32 are individually disposed between adjacent ridges 30 such that the plurality of ridges 30 and the plurality of valleys 32 form a corrugated configuration.

In the embodiment shown in FIG. 1, the pair of rails 26 are individually disposed within a pair of the plurality of valleys 32. The disposition of the pair of rails 26 within the valleys 32 reduces how far the pair of rails 26 extend above the plurality of ridges 30 in the vehicle vertical direction Z in comparison to being mounted to the plurality of ridges 30, thus reducing the amount of usable space that is occupied by the pair of rails 26 within the bed 24. However, the pair of rails 26 may be mounted to any suitable portion of the bed 24, including to the plurality of ridges 30.

The pair of rails 26 may be mounted to the bed 24 with fasteners, by welding, by chemical bonding, etc. While the pair of rails 26 are utilized in the embodiment shown in FIG. 1, it is to be appreciated that any number of rails 26 may be utilized.

With continued reference to FIG. 1, the storage system 22 further includes a drawer module 34. As will be better understood in the description below, the drawer module 34 may be selectively mounted to the rail 26 such that drawer module 34 may be placed into the bed 24 and locked to the bed 24 by engaging the pair of rails 26 or disengaged from the pair of rails 26 and removed from the bed 24, allowing the bed 24 to be used for other purposes.

The drawer module 34 includes a housing 36 and a drawer 38 movable into and out of the housing 36. The drawer 38 may be configured to receive items to be stored within the drawer module 34 (e.g., off road gear, tools, food, clothing, camping equipment, etc.). Moving the drawer 38 out of the housing 36 allows access to the items therein while moving the drawer 38 into the housing 36 secures the items within the housing 36. While the drawer module 34 shown in FIG. 1 has one drawer 38, the drawer module 34 may be configured to include any number of drawers 38.

The housing 36 includes a plurality of walls 40. More specifically, in the embodiment shown in FIG. 1, the plurality of walls 40 is formed from six walls 40 that collectively form a rectangular prism configuration of the housing 36. Four of the six walls 40 form sides of the housing 36 and two of the six walls 40 form a top and a bottom of the housing 36. One of the plurality of walls 40 is configured such that the drawer 38 extends therethrough. However, any number of walls 40 may be utilized by the housing 36.

The housing 36 includes a plurality of retainers 42. More specifically, the plurality of retainers 42 may be formed from four retainers 42 that each extend in the vehicle vertical direction Z and individually form one of four corners between the four walls 40 on the sides of the housing 36. However, the number of retainers 42 may vary depending on the number of walls 40 utilized and the configuration of the housing 36.

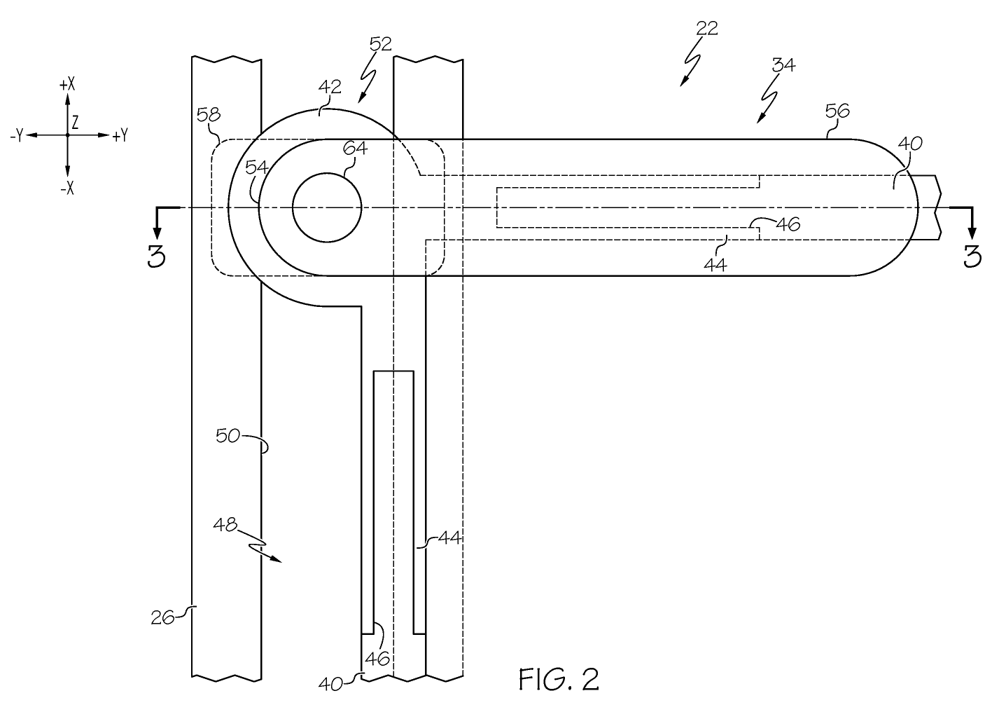

FIG. 2 schematically depicts a top plan view of a portion of the storage system 22. Specifically, FIG. 2 shows a corner of the drawer module 34 formed by one of the plurality of retainers 42 (e.g., the retainer 42 disposed toward the front and left side of the vehicle 20) and adjacent components. Features of the retainer 42 and the adjacent components as shown in FIG. 2 are directly applicable to all of the retainers 42 and their adjacent components. With reference to FIG. 2, each of the plurality of retainers 42 has a pair of joints 44 configured to mount the retainer 42 to a pair of the plurality of walls 40. More specifically, the pair of joints 44 are configured to mount the retainer 42 to the pair of the plurality of walls 40 that are adjacent the retainer 42. Each of the pair of joints 44 may define a groove 46 that receives a portion of the respective wall 40 therein to form a corner of the housing 36. The wall 40 may be mounted to the joint 44 by an interference fit within the groove 46, by mechanical fasteners, by welding, by chemical bonding, etc.

As the housing 36 is configured as a rectangular prism, the pair of joints 44 as shown in FIG. 2 are positioned orthogonal to one another. However, variations in the configuration of the housing 36 may vary the relative position of the pair of joints 44.

With reference to FIG. 1, each of the pair of rails 26 defines an interior 48 and a channel 50 opening into the interior 48. The drawer module 34 further includes a plurality of quick-mount attachments 52 mounted to the housing 36. More specifically, the plurality of quick-mount attachments 52 are formed from four quick-mount attachments 52 that individually correspond with the four retainers 42. However, the number of quick-mount attachments 52 may vary depending on the configuration of the housing 36. Furthermore, the plurality of quick-mount attachments 52 may be used with a portion of the plurality of retainers 42 such that some of retainers 42 do not have a corresponding quick-mount attachment 52.

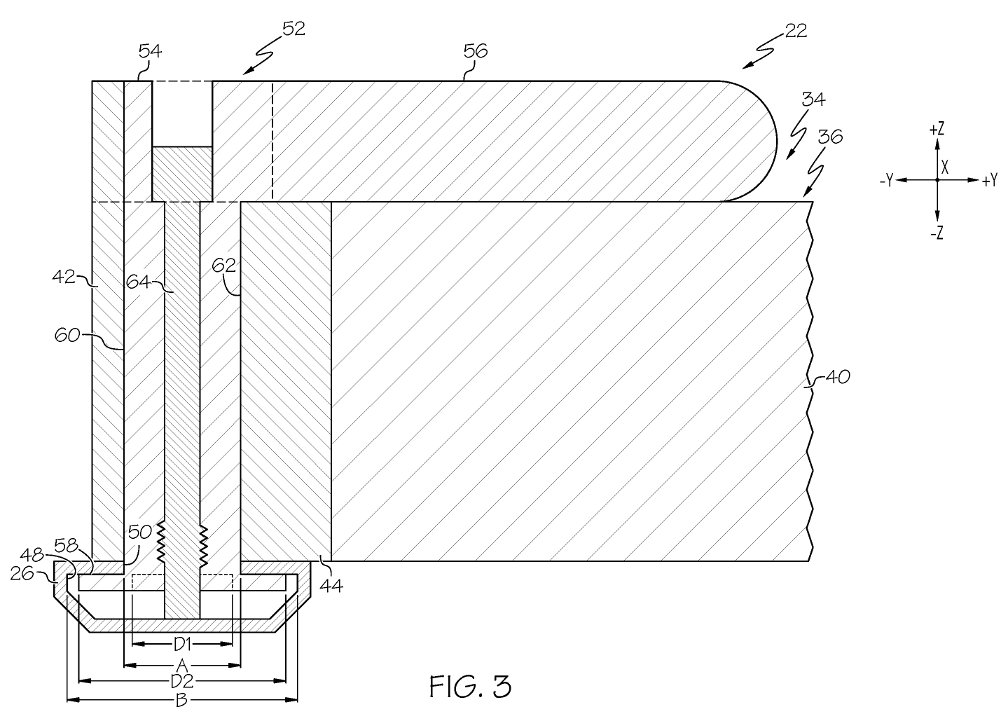

With reference to FIGS. 2 and 3, each of the plurality of quick-mount attachments 52 includes a lever 54 having a handle 56, a shoulder 58, and a body 60 extending between and mounted to each of the handle 56 and the shoulder 58. The shoulder 58 is shaped to pass through the channel 50 in a first position (shown with solid lines in FIG. 3) to allow movement of the lever 54 through the channel 50 into and out of the interior 48 of the rail 26 and to engage the rail 26 and inhibit the movement through the channel 50 in a second position (shown with phantom lines in FIG. 3) for retaining the shoulder 58 in the interior 48 of the rail 26 and mounting the housing 36 to the rail 26.

With reference to FIG. 1, the interior 48 and the channel 50 of each of the pair of rails 26 extend longitudinally in the vehicle longitudinal direction X, allowing the drawer module 34 to be positioned in an infinite number of positions along the pair of rails 26 in the vehicle longitudinal direction X. Moreover, two of the four quick-mount attachments 52 are disposed in one of the pair of rails 26 and the other two of the four quick-mount attachments 52 are disposed in the other one of the pair rails 26. However, any number of quick-mount attachments 52 may be disposed within an individual rail 26.

With reference to FIG. 3, each of the plurality of retainers 42 defines an aperture 62. The aperture 62 extends through the retainer 42 in the vehicle vertical direction Z. For each of the plurality of retainers 42, the body 60 of the lever 54 corresponding to the retainer 42 extends through the aperture 62 and is rotatable relative to the retainer 42. More specifically, each of the aperture 62 and the body 60 has a circular cross-section allowing rotation therebetween. Rotation of the lever 54 relative to the retainer 42 moves the lever 54 between the first position and the second position. However, the lever 54 may be configured to move in any suitable way between the first position and the second position.

The handle 56 of the lever 54 is positioned orthogonal to the body 60 of the lever 54, as shown in FIG. 3. As such, the handle 56 extends parallel to the wall 40 defining the top of the housing 36, allowing the handle 56 to be grasped by an operator and have torque exerted thereon to rotate the lever 54 about the vehicle vertical direction Z between the first position and the second position.

With continued reference to FIG. 3, for each of the plurality of levers 54, the shoulder 58 has a first dimension D1 and a second dimension D2 orthogonal to the first dimension D1. More specifically, the shoulder 58 has a generally rectangular configuration, with the first dimension D1 measuring the width of the shoulder 58 and the second dimension D2 measuring the length of the shoulder 58. Therefore, the first dimension D1 is less than the second dimension D2. However, any suitable shape and configuration of the shoulder 58 may be utilized in which the first dimension D1 is less than the second dimension D2. For each of the pair of rails 26, the interior 48 of the rail 26 has an interior dimension A that extends in the vehicle lateral direction Y. The interior dimension A is generally uniform along the length of the rail 26 in the vehicle longitudinal direction X. The second dimension D2 is less than the interior dimension A to allow rotation of the lever 54 between the first position and the second dimension D2.

For each of the pair of rails 26, the channel 50 has a width opening dimension B that extends in the vehicle lateral direction Y. The width opening dimension B is generally uniform along the length of the rail 26 in the vehicle longitudinal direction X. The first dimension D1 is aligned with and less than the width opening dimension B in the first position. As such, with each of the plurality of levers 54 in the first position the drawer module 34 is disposed on the pair of rails 26 is in an unlocked position, in which the drawer module 34 may be lifted in the vehicle vertical direction Z and the shoulders 58 may be removed from the interior 48 of the respective rails 26 and through the channel 50 of the respective rails 26 to remove the drawer module 34 from the bed 24 of the vehicle 20. Likewise, to place the drawer module 34 on the pair of rails 26, each of the plurality of levers 54 are disposed in the first position, allowing the drawer module 34 to be lowered in the vehicle vertical direction Z such that the shoulders 58 move through the channel 50 of the respective rails 26 into the interior 48 of the respective rails 26.

The second dimension D2 is aligned with and greater than the width opening dimension B in the second position. As such, with each of the plurality of levers 54 in the second position the drawer module 34 is disposed on the pair of rails 26 in a locked position, in which lifting the drawer module 34 in the vehicle vertical direction Z causes the shoulders 58 to engage the respective rails 26 adjacent the respective channels 50. Therefore, in the locked position, removal of the drawer module 34 from the bed 24 of the vehicle 20 is inhibited.

With continued reference to FIG. 3, each of the plurality of quick-mount attachments 52 includes a bolt 64 extending through, and threaded to, the lever 54. The bolt 64 is engageable with the rail 26 to raise the shoulder 58 toward the channel 50 for engagement with the rail 26. More specifically, the threaded engagement of the bolt 64 with the lever 54 allows the bolt 64 to move relative to the lever 54 in the vehicle vertical direction Z. Rotation of the bolt 64 may extend the bolt 64 down into the interior 48 of the rail 26 and into contact with the rail 26. Continued rotation of the bolt 64 may move the lever 54 upwardly in the vehicle vertical direction Z, moving the shoulder 58 toward the channel 50. Spacing between the shoulder 58 and the rail 26 adjacent the channel 50 (e.g., lash) may be adjusted with rotation of the bolt 64. Continued upward movement of the shoulder 58 reduces the spacing between the shoulder 58 and the rail 26 creating friction therebetween that reduces noise, vibration, and harshness (NVH) and prevents movement of the drawer module 34 along the pair of rails 26 in the vehicle longitudinal direction X. However, the increased friction increases the torque required to rotate the lever 54. Therefore, the operator may adjust the position of the bolt 64 relative to the lever 54 in the vehicle vertical direction Z to achieve a desired combination of the characteristics described above.

It should now be understood that embodiments of the present disclosure are directed to a storage system mountable to a vehicle. The storage system may include a housing, a drawer movable into and out of the housing, and a rail configured to be mounted to a bed of the vehicle, with the rail defining an interior and a channel opening into the interior. The storage system may further include a quick-mount attachment mounted to the housing. The quick-mount attachment may include a lever having a handle, a shoulder, and a body extending between and mounted to each of the handle and the shoulder. The shoulder may be shaped to pass through the channel in a first position to allow movement of the lever through the channel into and out of the interior of the rail and to engage the rail and inhibit the movement through the channel in a second position for retaining the shoulder in the interior of the rail and mounting the housing to the rail. When the lever is in the second position, the housing is mounted to the rail and secured relative to the vehicle. When the lever is in the first position, the housing and the drawer may be removed from the vehicle with only the rail left behind, freeing up space within the vehicle. Various embodiments and benefits of the storage box system and the storage box will be described in more detail herein.

It is noted that the terms "substantially," “generally,” and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A storage system mountable to a vehicle, the storage system comprising:
a housing;
a drawer movable into and out of the housing;
a rail configured to be mounted to a bed of the vehicle, with the rail defining an interior and a channel opening into the interior; and
a quick-mount attachment mounted to the housing, the quick-mount attachment comprising a lever having a handle, a shoulder, and a body extending between and mounted to each of the handle and the shoulder, the shoulder shaped to pass through the channel in a first position to allow movement of the lever through the channel into and out of the interior of the rail and to engage the rail and inhibit the movement through the channel in a second position for retaining the shoulder in the interior of the rail and mounting the housing to the rail.

2. The storage system of claim 1, wherein the quick-mount attachment comprises a bolt extending through, and threaded to, the lever, the bolt engageable with the rail to raise the shoulder toward the channel for engagement with the rail.

3. The storage system of claim 1, wherein the channel of the rail has a width opening dimension and the shoulder has a first dimension and a second dimension orthogonal to the first dimension, the first dimension aligned with and less than the width opening dimension in the first position and the second dimension aligned with and greater than the width opening dimension in the second position.

4. The storage system of claim 3, wherein the interior of the rail has an interior dimension, the second dimension is less than the interior dimension to allow rotation of the lever between the first position and the second dimension.

5. The storage system of claim 1, wherein the housing comprises a retainer defining an aperture, the body of the lever extending through the aperture and rotatable relative to the retainer.

6. The storage system of claim 5, wherein each of the aperture and the body has a circular cross-section allowing rotation therebetween.

7. The storage system of claim 5, wherein the housing has a plurality of walls and the retainer has a pair of joints configured to mount the retainer to a pair of the plurality of walls.

8. The storage system of claim 7, wherein the pair of joints are positioned orthogonal to one another.

9. The storage system of claim 1, wherein the handle of the lever is positioned orthogonal to the body of the lever.

10. The storage system of claim 1, wherein the shoulder has a generally rectangular configuration.
